(19) United States
(12) Patent Application Publication
(10) Pub. No.: US 2014/0059901 A1
(43) Pub. Date: Mar. 6, 2014

(54) SPRING ASSEMBLY FOR LATCH MECHANISM

(71) Applicant: Harnischfeger Technologies, Inc., (unknown)

(72) Inventors: Richard L. Nicoson, Hartford, WI (US); Troy Hottmann, Oconomowoc, WI (US)

(21) Appl. No.: 14/012,615

(22) Filed: Aug. 28, 2013

Related U.S. Application Data
(60) Provisional application No. 61/694,443, filed on Aug. 29, 2012.

(51) Int. Cl. E02F 3/407; F16F 1/06

(52) U.S. Cl. CPC E02F 3/4075; F16F 1/06
USPC 37/445; 267/166; 292/219

(57) ABSTRACT

A spring assembly for a latch mechanism includes a spring, a first support, and a second support. The spring includes a first end, a second end, and a plurality of coils extending therebetween. The coils define an internal helical surface. The first support is configured to be coupled to a first pivoting member. The first support includes a grooved surface for threadingly engaging at least a portion of the internal helical surface of the spring proximate the first end. The second support is configured to be coupled to a second pivoting member. The second support includes a grooved surface for threadingly engaging at least a portion of the internal helical surface of the spring proximate the second end.

### CROSS-REFERENCE TO RELATED APPLICATIONS

This application claims the benefit of prior-filed, co-pending U.S. Provisional Application No. 61/694,443, filed Aug. 29, 2012, the entire contents of which are incorporated herein by reference.

### BACKGROUND

The present invention relates to the field of mining shovels. Specifically, the present invention discloses a dipper door latch mechanism.

A conventional mining shovel includes a dipper having a dipper door pivotably coupled to a dipper body. During operation, the shovel operator releases a latch, thereby permitting the door to pivot to an open position and unload the contents of the dipper. The operator then moves the dipper into a tuck position so that the door falls back against the dipper body. The door slams shut, and a latch mechanism secures the door against the dipper body. The latch mechanism may include a linkage having multiple pivoting members and a tension spring biasing the linkage alternatively toward a locked state or an unlocked state. The spring is typically coupled to the links at its ends, creating a stress concentration at these points. Over time, the stress on the spring causes the spring to break, and the subsequent time for repair prevents the dipper from being used. The stress also alters the nominal tension force exerted by the spring, changing the response behavior of the spring and therefore changing the behavior of the latch mechanism.

### SUMMARY

In one embodiment, the invention provides a spring assembly for a latch mechanism including a first pivoting member and a second member pivotably coupled to the first member. The spring assembly includes a spring, a first support, and a second support. The spring includes a first end, a second end, and a plurality of coils extending therebetween. The coils define an internal helical surface. The first support is configured to be coupled to the first pivoting member. The first support includes a grooved surface for threadingly engaging at least a portion of the internal helical surface of the spring proximate the first end. The second support is configured to be coupled to the second pivoting member. The second support includes a grooved surface for threadingly engaging at least a portion of the internal helical surface of the spring proximate the second end.

In another embodiment, the invention provides a latch mechanism for a dipper. The latch mechanism includes a first pivoting member, a second member pivotably coupled to the first member, a spring, a first spring support, and a second spring support. The spring includes a first end, a second end, and a plurality of coils extending therebetween. The first spring support includes a first end coupled to the first pivoting member and a second end having a first helically-grooved surface. The first helically-grooved surface engages an internal surface of at least a portion of the plurality of coils proximate the first end of the spring such that rotation of the first spring support relative to the spring threads the first helically-grooved surface into the plurality of coils. The second spring support includes a first end coupled to the second pivoting member and a second end having a second helically-grooved surface. The second helically-grooved surface engages an internal surface of at least a portion of the plurality of coils proximate the second end of the spring such that rotation of the second spring support relative to the spring threads the second helically-grooved surface into the plurality of coils.

In yet another embodiment, the invention provides a dipper for a mining shovel. The dipper includes a body having an opening, a door pivotably coupled to the body to selectively close the opening, and a latch mechanism for releasably securing the door relative to the body. The latch mechanism includes a first pivoting member, a second member pivotably coupled to the first member, a spring, a first spring support, and a second spring support. The spring includes a first end, a second end, and a plurality of coils extending therebetween. The first spring support includes a first end coupled to the first pivoting member and a second end having a first helically-grooved surface. The first helically-grooved surface engages at least a portion of the plurality of coils proximate the first end of the spring such that rotation of the first spring support relative to the spring threads the first helically-grooved surface into the plurality of coils. The second spring support includes a first end coupled to the second pivoting member and a second end having a second helically-grooved surface. The second helically-grooved surface engages at least a portion of the plurality of coils proximate the second end of the spring such that rotation of the second spring support relative to the spring threads the second helically-grooved surface into the plurality of coils.

Other aspects of the invention will become apparent by consideration of the detailed description and accompanying drawings.

### BRIEF DESCRIPTION OF THE DRAWINGS

FIG. 1 is a perspective view of a mining shovel.

FIG. 2 is a perspective view of a bail and a dipper.

FIG. 3 is a perspective view of a portion of a dipper body.

FIG. 4 is a perspective view of a portion of a dipper door.

FIG. 5 is a perspective view of a latch mechanism.

FIG. 6 is a perspective view of a spring assembly for use with the latch mechanism of FIG. 5.

FIG. 7 is an exploded perspective view of the spring assembly of FIG. 6.

FIG. 8 is a perspective view of a first spring support engaging a portion of a spring.

FIG. 9 is a perspective view of a second spring support engaging a portion of the spring.

FIG. 10 is a reverse perspective view of a portion of the latch mechanism of FIG. 5.

FIG. 11 is a cross-section view of a portion of the latch mechanism taken along line 11-11 of FIG. 10.

FIG. 12 is a perspective view of a portion of the latch mechanism of FIG. 5.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

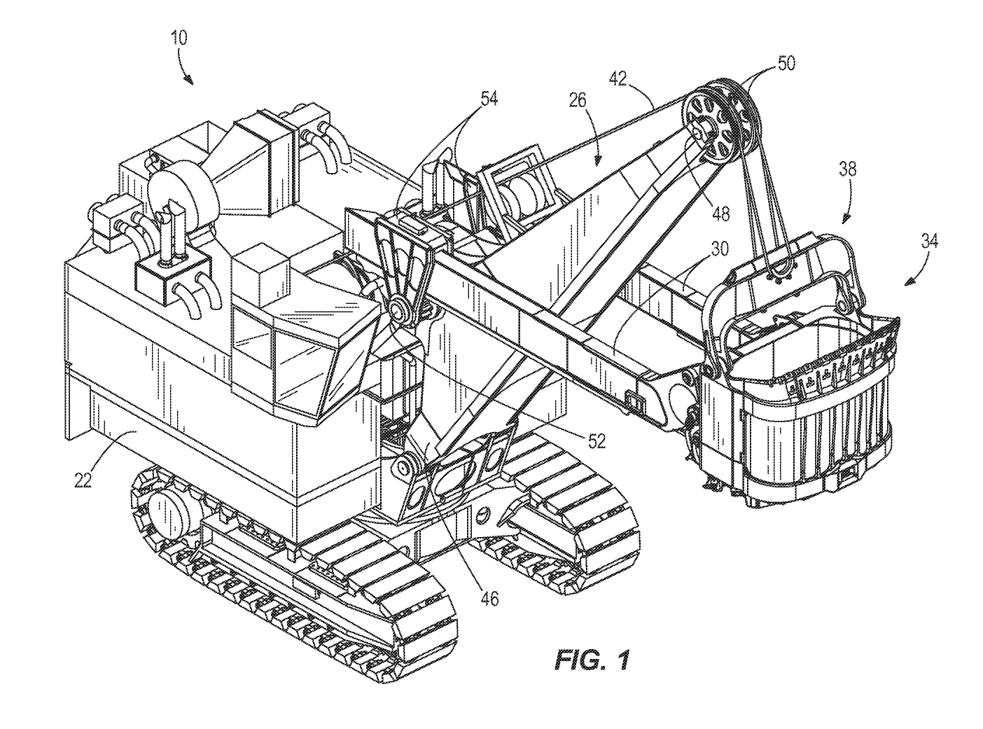

As shown in FIG. 1, a mining shovel 10 rests on a support surface and includes a base 22, a boom 26, a handle 30 moveably coupled to the boom 26, a dipper 34, and a bail 38 coupled to the dipper 34. The base 22 includes a hoist drum (not shown) for reeling in and paying out a cable or rope 42. The boom 26 includes a first end 46 coupled to the base 22, a second end 48 opposite the first end 46, a boom sheave 50 coupled to the second end 48, a shipper shaft 52 extending through the boom 26, and a saddle block 54 pivotably coupled to the boom 26 via the shipper shaft 52. The handle 30 is inserted into the saddle block 54 and is translationally and rotationally movable relative to the boom 26. The dipper 34 is supported on an end of the handle 30. The rope 42 passes over the boom sheave 50 and is coupled to the dipper 34 by the bail assembly 38. The dipper 34 is raised or lowered as the rope 42 is reeled in or paid out by the hoist drum.

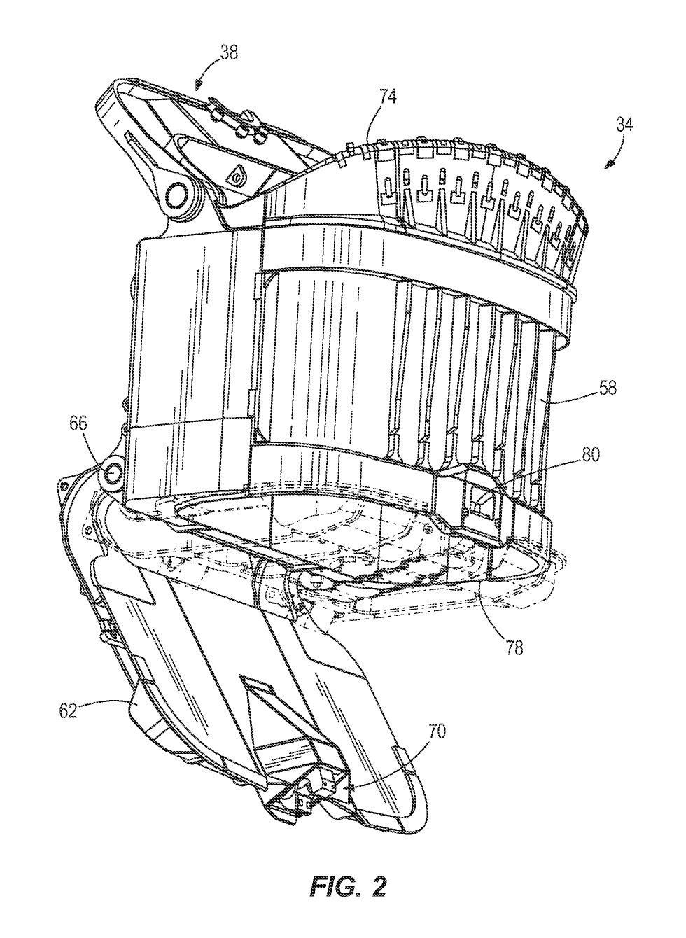

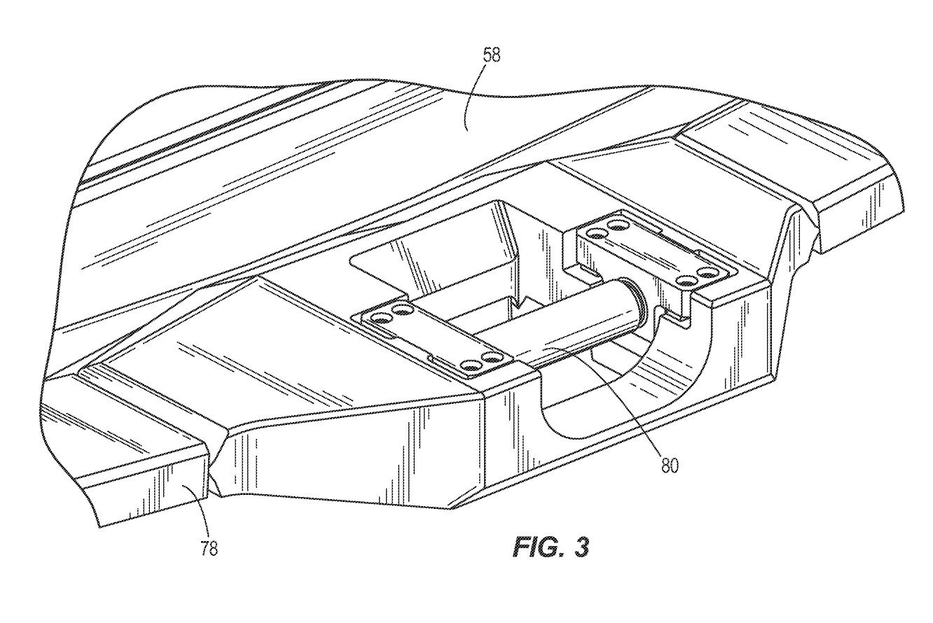

Referring to FIG. 2, the dipper 34 includes a dipper body 58, a dipper door 62 pivotably coupled to the dipper body 58 about a hinge pin 66, a snubber (not shown) for dampening motion of the dipper door 62, and a latch mechanism 70 for releasably securing the dipper door 62 to the dipper body 58. In the illustrated embodiment, the dipper body 58 includes a first end, or a material receiving end 74, and a second end, or a material discharging end 78. The dipper door 62 pivots about the hinge pin 66 proximate the material discharging end 78 between a first, or open, position (shown in solid lines in FIG. 2) and a second, or closed, position (shown in broken lines in FIG. 2). In the embodiment illustrated in FIGS. 2 and 3, the latch mechanism 70 (FIG. 2) is coupled to the dipper door 62 and engages a latch pin 80 coupled to the dipper body 58 and positioned proximate a lower edge of the dipper body 58. In other embodiments, the latch mechanism 70 is coupled to the dipper body 58 and the latch pin 80 is coupled to the dipper door 62.

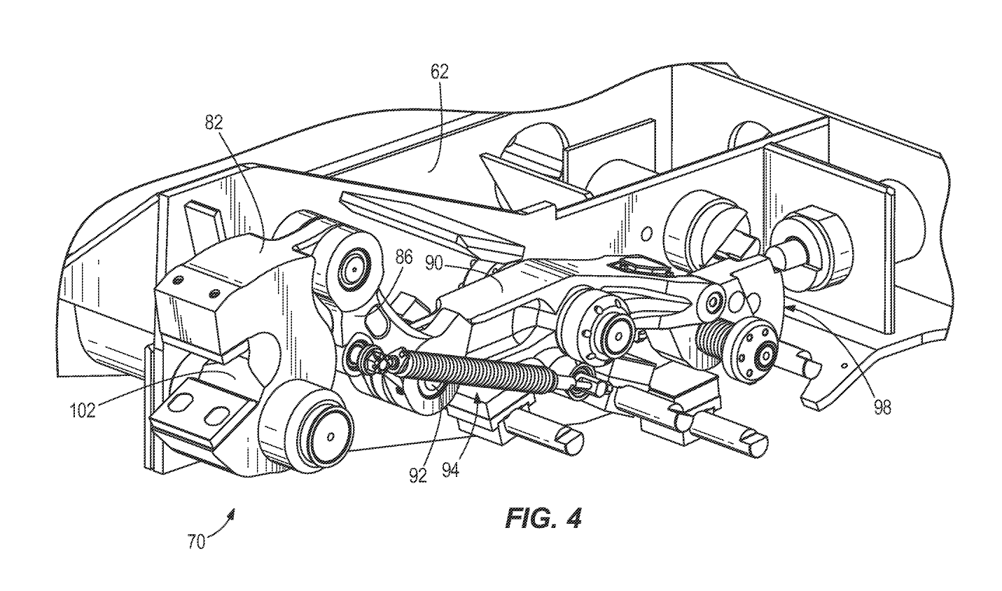

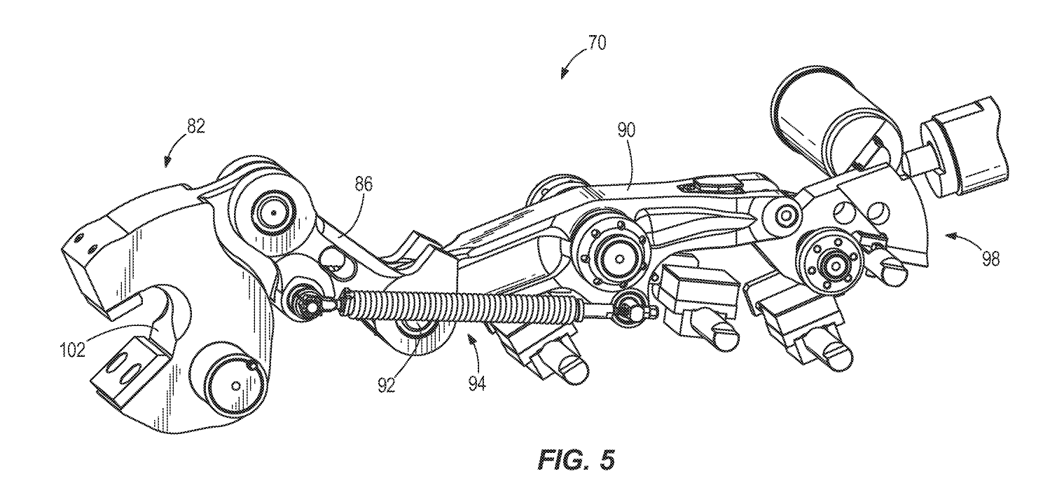

As shown in FIGS. 4 and 5, the latch mechanism 70 is positioned on the dipper door 62 (FIG. 4). The latch mechanism 70 includes a primary cam or primary latch member 82, a first link 86 pivotably coupled to the primary latch member 82, a second link 90 pivotably coupled to the first link 86 at a pivot joint 92, a spring assembly 94, and a secondary cam or secondary latch 98. The latch mechanism 70 is moveable between a locked state and an unlocked state. The primary latch member 82 includes a jaw 102 that is pivotable relative to the door 62. The jaw 102 is positioned to engage the latch pin 80 (FIG. 3) when the latch mechanism 70 is in the locked state and is positioned to release the latch pin 80 (FIG. 3) when the latch mechanism 70 is in the unlocked state.

The second link 90 is pivotable relative to the door 62, and the first link 86 is pivotably coupled between the primary latch member 82 and the second link 90. The spring assembly 94 is coupled between the first link 86 and the second link 90, and exerts a spring force therebetween to pivot the first link 86 and the second link 90 about the pivot joint 92. In the embodiment shown in FIG. 5, the spring assembly 94 biases the latch mechanism 70 toward the unlocked state. In one embodiment, the spring assembly 94 is positioned in an over-center configuration with the pivot joint 92, and the spring force biases the latch mechanism 70 toward either the locked state or the unlocked state depending on the relative position of the pivot joint 92 with respect to the spring assembly 94. Also, in the illustrated embodiment, the latch mechanism 70 includes a spring assembly 94 positioned on each side of the first link 86 and the second link 90.

The secondary latch 98 engages an end of the second link 90 to maintain the latch mechanism 70 in the locked state. The weight of the dipper door 62 and material supported within the dipper body 58 cause the latch pin 80 to exert a reaction force on the latch mechanism 70. Actuating or releasing the secondary latch 98 permits the second link 90 to pivot, and the reaction force of the latch pin 80 causes the primary latch member 82 to pivot out of engagement with the latch pin 80. The associated movement of the first link 86 and the second link 90 causes the pivot joint 92 to move, toggling the spring assembly 94 so that the spring force biases the latch mechanism 70 toward the unlocked state.

When the operator desires to close the dipper door 62, the dipper 34 is moved to a tuck position so that the door 62 pivots to the closed position. The latch pin 80 contacts with primary latch member 82, pivoting the components of the latch mechanism 70 to the locked state. The movement of the pivot joint 92 toggles the spring assembly 94 so that the spring assembly 94 biases the latch mechanism 70 toward the locked state. The secondary latch 98 engages the end of the second link 90 to hold the latch mechanism 70 in the locked state. The operation of the latch mechanism 70 is described in further detail in U.S. patent application Ser. No. 12/986,933, filed Jan. 7, 2011, the entire contents of which are incorporated herein by reference.

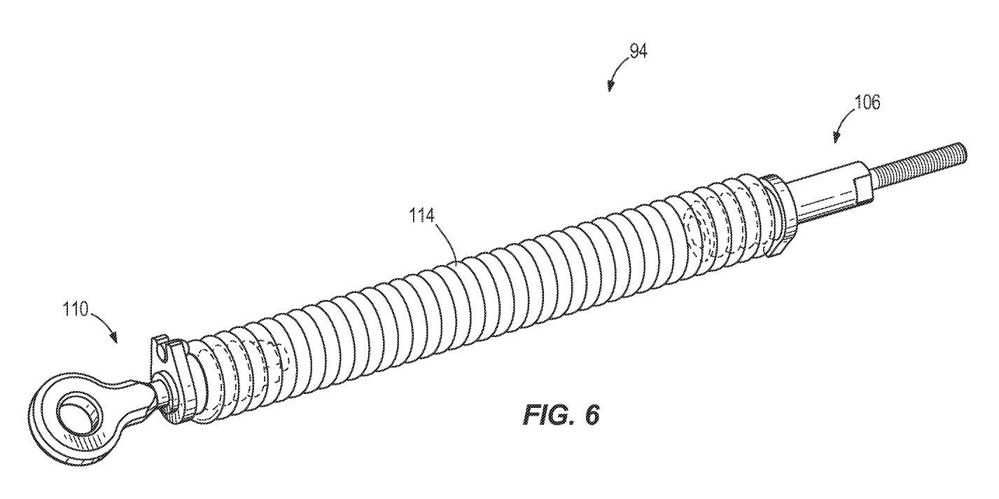

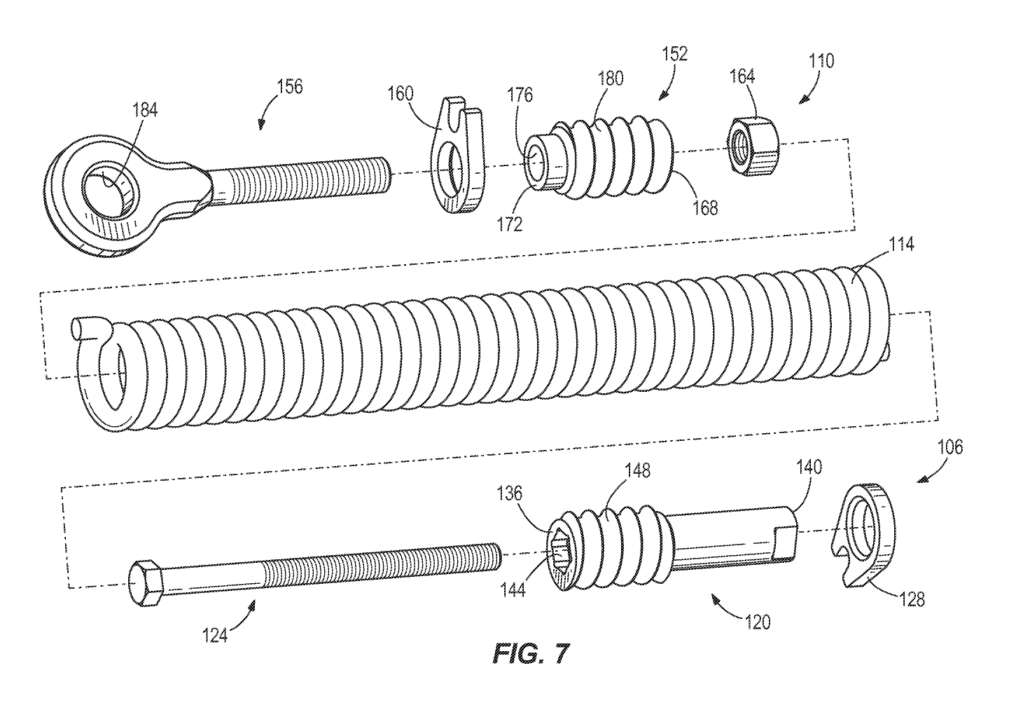

As shown in FIG. 6, the spring assembly 94 includes a first support 106, a second support 110, and a spring element such as a coil spring 114 extending between the first support 106 and the second support 110. Referring to FIG. 7, the first support 106 includes a first plug 120, a first bolt 124, and a first retaining collar 128. The first plug 120 is an elongated member having a first end 136, a second end 140, and a bore 144 extending longitudinally through the first plug 120 between the first end 136 and the second end 140. The first plug 120 further includes a threaded or grooved portion 148 proximate the first end 136. The first bolt 124 is inserted through the bore 144 from the first end 136 and extends through the first plug 120 so that an end of the bolt 124 is positioned away from the grooved portion 148. The first retaining collar 128 is positioned on the first plug 120 proximate the second end 140.

Similarly, the second support 110 includes a second plug 152, a second bolt 156, a second retaining collar 160, and a nut 164. The second plug 152 is an elongated member having a first end 168, a second end 172, and a bore 176 extending longitudinally through the second plug 152 between the first end 168 and the second end 172. The second plug 152 further includes a threaded or grooved portion 180 proximate the first end 168. In the illustrated embodiment, the second bolt 156 is inserted through the bore 176 from the second end 172 and extends through the plug 152 so that an end of the bolt 156 is positioned proximate the grooved portion 180. The nut 164 is threaded onto the end of the second bolt 156 to secure the bolt 156 to the second plug 152. The nut 164 can be retained in various ways such as welding, for example. The second bolt 156 includes an opening or eye 184 for coupling the second support 110 to the first link 86 (FIG. 12). The second retaining collar 160 is positioned on the second plug 152 proximate the second end 172 between the eye 184 and the grooved portion 180.

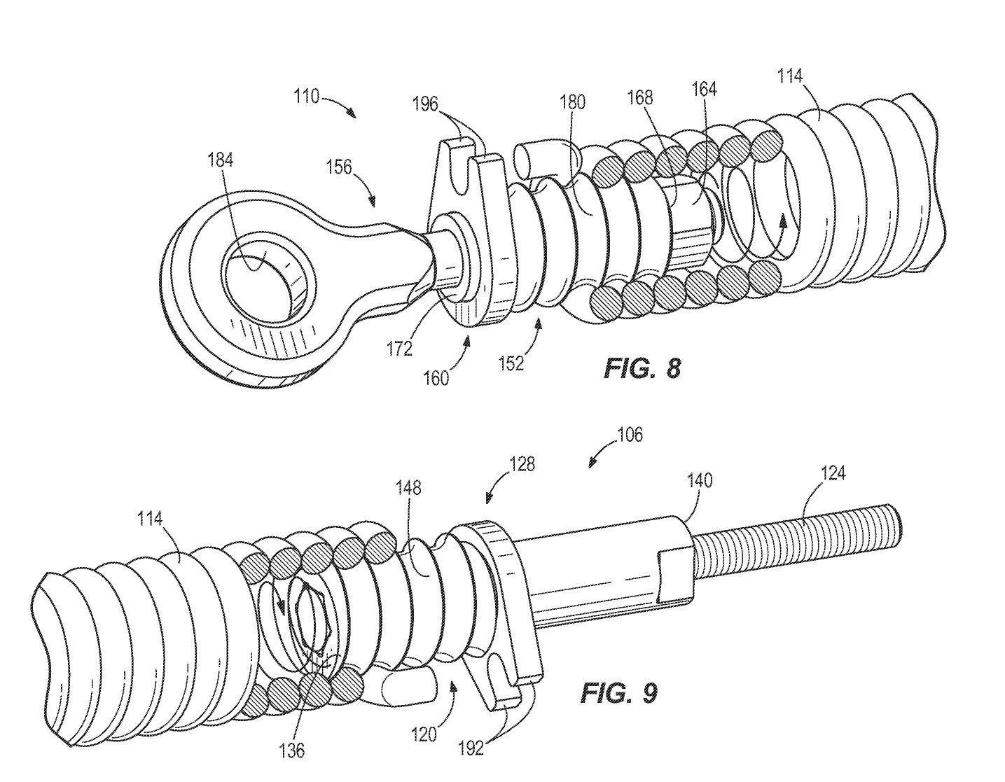

As best shown in FIGS. 8 and 9, the spring 114 is formed as stacked coils, which form an internal helical surface. As shown in FIG. 8, the first support 106 is coupled to the spring 114 by inserting the first end 136 of the first plug 120 into the spring 114 such that the grooved portion 148 receives the internal helical surface of a portion of the coils. The first plug 120 is rotated, thereby threading the grooved portion 148 into the coils of the spring 114. Similarly, as shown in FIG. 9, the second support 110 is coupled to another end of the spring 114 by inserting the first end 168 of the second plug 152 into the spring 114, threading the grooved portion 180 into the internal helical surface of the spring 114 as described above with respect to the first support 106.

In the illustrated embodiment, the first retaining collar 128 includes a pair of arms 192 forming a forked portion that receives one end of the spring 114. Similarly, the second retaining collar 160 includes a pair of arms 196 forming a forked portion that receives the other end of the spring 114. The retaining collars 128, 160 can be secured to the plugs 120, 152, respectively, in various ways including welding, for example. The arms 192, 196 provide anti-rotation stops to prevent the spring 114 from unthreading or uncoiling from the first plug 120 or the second plug 154, respectively.

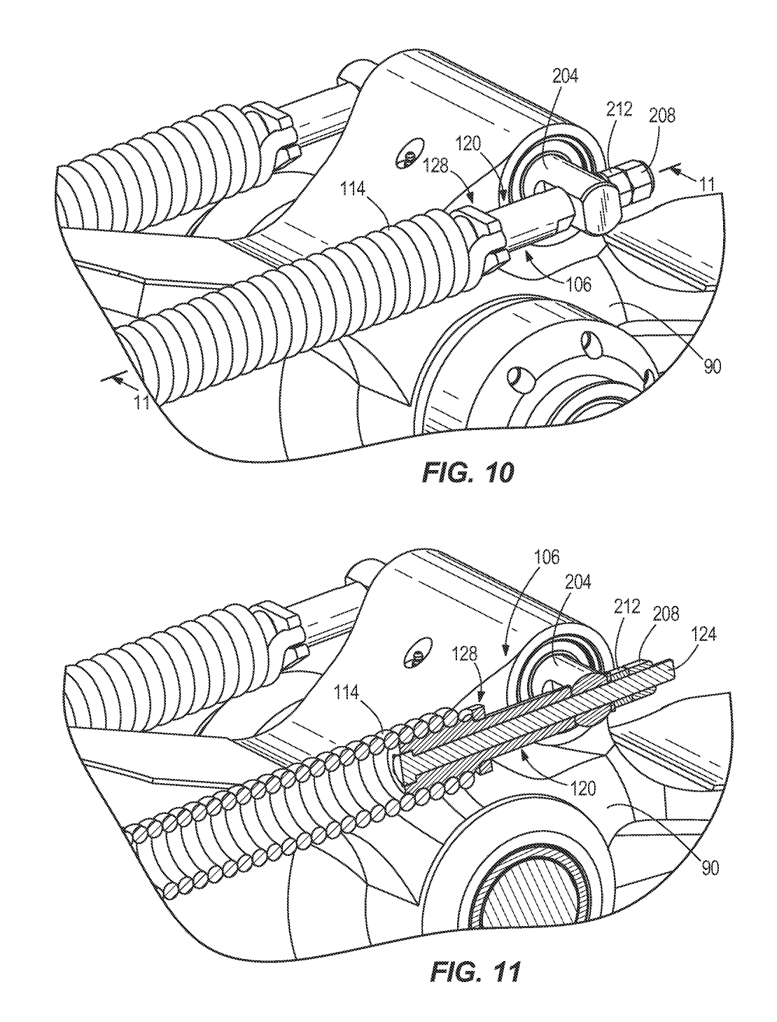

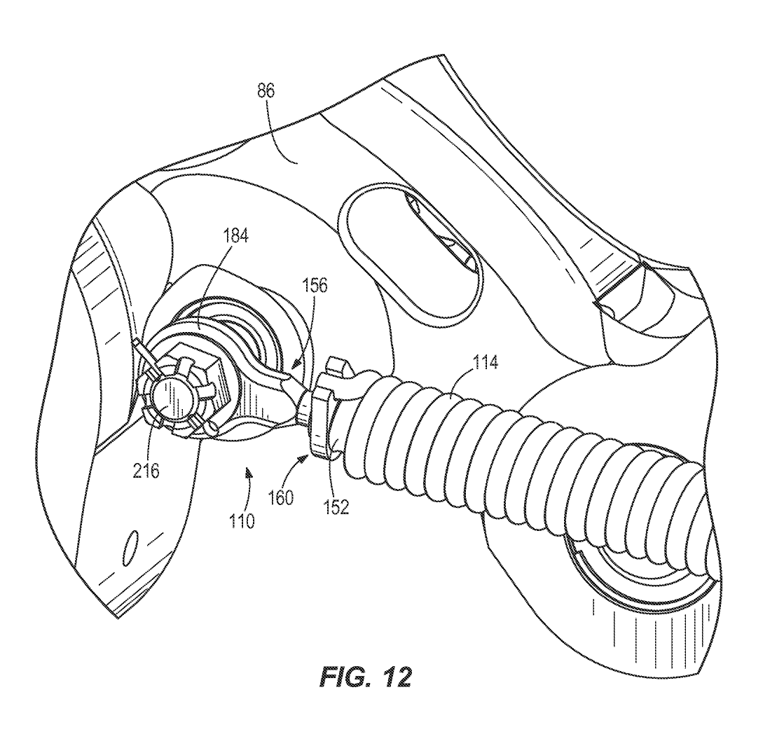

In the embodiment shown in FIGS. 10 and 11, the first bolt 124 (FIG. 11) is inserted through a lug 204 coupled to the second link 90. The first bolt 124 is secured to the lug 204 with a nut 208. The connection between the first plug 120 and the second link 90 can be adjusted by threading or unthreading the nut 208 with respect to the first bolt 124. In addition, one or more spacers 212 may be positioned on the first bolt 124 between the lug 204 and the plug 120 or between the lug 204 and the nut 208. These adjustments permit the user to change the pre-load on the spring assembly 94 as necessary to produce the desired response behavior of the latch mechanism 70 during operation.

As shown in FIG. 12, the eye 184 is positioned around a pin 216 coupled to the first link 86 to pivotably couple the second support 110 to the first link 86. The eye 184 can be secured to the pin 216 in various ways, such as by a cotter pin inserted through a hole in the pin 216.

The threaded engagement between each plug 120, 152 and the spring 114 provides a secure coupling between the spring 114 and the supports 106, 110. In addition, the threaded engagement between the grooved surfaces 148, 180 and the internal helical surface of the spring reduces stress concentrations during operation by distributing the load over multiple spring coils instead of applying the load only at the ends of the spring 114. Reducing stress concentrations on the spring 114 prevents malfunction and improves reliability of the spring assembly 94, which in turn reduces the amount of time required for maintenance of the latch mechanism 70.

Thus, the invention provides, among other things, a spring assembly for a latch mechanism. Although the invention has been described in detail with reference to certain preferred embodiments, variations and modifications exist within the scope and spirit of one or more independent aspects of the invention as described. Various features and advantages of the invention are set forth in the following claims.

1. A spring assembly for a latch mechanism, the latch mechanism including a first pivoting member and a second member pivotably coupled to the first member, the spring assembly comprising:
a spring including a first end, a second end, and a plurality of coils extending therebetween, the coils defining an internal helical surface;
a first support configured to be coupled to the first pivoting member, the first support including a grooved surface for threadingly engaging at least a portion of the internal helical surface of the spring proximate the first end; and
a second support configured to be coupled to the second pivoting member, the second support including a grooved surface for threadingly engaging at least a portion of the internal helical surface of the spring proximate the second end.

2. The spring assembly of claim 1, wherein the first support includes a threaded bolt extending away from the grooved surface and for engaging the first pivoting member.

3. The spring assembly of claim 2, further comprising a nut engaging the threaded bolt, wherein threading and unthreading the nut adjusts a pre-load force on the spring.

4. The spring assembly of claim 1, wherein the second support includes an eye for coupling to the second pivoting member.

5. The spring assembly of claim 1, wherein the first support includes a collar having at least one arm engaging the first end of the spring to secure the first support against rotation with respect to the spring.

6. A latch mechanism for a dipper, the latch mechanism comprising:
a first pivoting member;
a second member pivotably coupled to the first member;
a spring including a first end, a second end, and a plurality of coils extending therebetween;
a first spring support including a first end coupled to the first pivoting member and a second end having a first helically-grooved surface, the first helically-grooved surface engaging an internal surface of at least a portion of the plurality of coils proximate the first end of the spring such that rotation of the first spring support relative to the spring threads the first helically-grooved surface into the plurality of coils; and
a second spring support including a first end coupled to the second pivoting member and a second end having a second helically-grooved surface, the second helically-grooved surface engaging an internal surface of at least a portion of the plurality of coils proximate the second end of the spring such that rotation of the second spring support relative to the spring threads the second helically-grooved surface into the plurality of coils.

7. The latch mechanism of claim 6, wherein the first pivoting member includes a lug, and wherein the first end of the first spring support includes a threaded bolt, at least a portion of the threaded bolt extending through the lug to couple the first spring support to the first pivoting member.

8. The latch mechanism of claim 7, further comprising a nut engaging the portion of the threaded bolt extending through the lug to secure the bolt with respect to the lug, wherein threading and unthreading the nut adjusts a pre-load force on the spring.

9. The latch mechanism of claim 6, wherein the second pivoting member includes a protrusion, and wherein the first end of the second spring support includes an opening for receiving the protrusion to couple the second spring support to the second pivoting member.

10. The latch mechanism of claim 6, wherein the first spring support includes a collar having at least one arm engaging the first end of the spring to secure the first spring support against rotation with respect to the spring.

11. The latch mechanism of claim 6, wherein the first pivoting member and the second pivoting member are coupled together at a pivot joint, the movement of the first pivoting member and the second pivoting member causing the pivot joint to pass across a line of action defined by the spring.

12. A dipper for a mining shovel, the dipper comprising:
a body including an opening;
a door pivotably coupled to the body to selectively close the opening;
a latch mechanism for releasably securing the door relative to the body, the latch mechanism including
a first pivoting member;
a second member pivotably coupled to the first member;
a spring including a first end, a second end, and a plurality of coils extending therebetween;
a first spring support including a first end coupled to the first pivoting member and a second end having a first helically-grooved surface, the first helically-grooved surface engaging at least a portion of the plurality of coils proximate the first end of the spring such that rotation of the first spring support relative to the spring threads the first helically-grooved surface into the plurality of coils; and
a second spring support including a first end coupled to the second pivoting member and a second end having a second helically-grooved surface, the second helically-grooved surface engaging at least a portion of the plurality of coils proximate the second end of the spring such that rotation of the second spring support relative to the spring threads the second helically-grooved surface into the plurality of coils.

13. The dipper of claim 12, wherein the first pivoting member includes a lug, and wherein the first end of the first spring support includes a threaded bolt, at least a portion of the threaded bolt extending through the lug to couple the first spring support to the first pivoting member.

14. The dipper of claim 13, further comprising a nut engaging the portion of the threaded bolt extending through the lug to secure the bolt with respect to the lug, wherein threading and unthreading the nut adjusts a pre-load force on the spring.

15. The dipper of claim 12, wherein the second pivoting member includes a protrusion, and wherein the first end of the second spring support includes an opening for receiving the protrusion to couple the second spring support to the second pivoting member.

16. The dipper of claim 12, wherein the first spring support includes a collar having at least one arm engaging the first end of the spring to secure the first spring support against rotation with respect to the spring.

17. The dipper of claim 12, wherein the first pivoting member and the second pivoting member are coupled together at a pivot joint, the movement of the first pivoting member and the second pivoting member causing the pivot joint to pass across a line of action defined by the spring.
